(19) United States
(12) Patent Application Publication
(10) Pub. No.: US 2013/0163443 A1
(43) Pub. Date: Jun. 27, 2013

(54) Blind Detection of VAMOS Capable Mobile Stations

(71) Applicants: Olof Liberg, Stockholm (SE); Benny Lennartson, Hagersten (SE); Mårten Sundberg, Stockholm (SE); Örjan Sjelvgren, Hasselby (SE)

(72) Inventors: Olof Liberg, Stockholm (SE); Benny Lennartson, Hagersten (SE); Mårten Sundberg, Stockholm (SE); Örjan Sjelvgren, Hasselby (SE)

(21) Appl. No.: 13/333,425

(22) Filed: Dec. 21, 2011

(51) Int. Cl. H04W 24/00; H04L 12/26

(52) U.S. Cl. 370/252

(57) ABSTRACT

A network performs blind detection of the VAMOS capability, at or above a predetermined SCPIR level, of mobile stations. The network transmits an AQPSK modulated message having a predetermined SCPIR level on a control channel or non-traffic portion of a traffic channel, and monitors the mobile station for an anticipated action taken in response. In some embodiments, the AQPSK modulated message is repeated to increase the probability of its reception. In some embodiments, AQPSK modulated messages are transmitted at varying SCPIR levels, to determine a minimum SCPIR level at which the mobile terminal is operative in VAMOS mode. The VAMOS capability and SCPIR level of mobile stations may be recorded, so that they may later be paired for VAMOS operation.

### TECHNICAL FIELD

The present invention relates generally to wireless communications, and in particular to blind detection of GSM VAMOS capability (i.e., SCPIR level) of mobile stations.

### BACKGROUND

The Global System for Mobile Communications (GSM) is a well-known and widely-deployed standard for wireless communication networks. Conventionally, the GSM protocol calls for the use of Gaussian Minimum-Shift Keying (GMSK) modulation; accordingly, all mobile stations operative in a GSM system can receive and decode GMSK modulated messages.

One extension to the GSM standard is known as Voice services over Adaptive Multi-user channels on One Slot (VAMOS). VAMOS doubles transceiver peak capacity and optimizes spectrum utilization, while reducing radio base station power consumption. In the downlink, VAMOS modulates signals for two users onto a single radio burst, via different training sequences and a 90° phase shift. Each signal is transmitted on a VAMOS subchannel. Each VAMOS subchannel may carry full rate or time-multiplexed half rate voice signals, independent of each other. Using only half rate, up to four users may be served in each GSM time slot.

The VAMOS specification defines an Adaptive Quadrature Phase Shift Keying (AQPSK) modulation, which modulates two voice signals onto two subchannels of a GSM channel. A key feature of this process is subchannel power control. The AQPSK modulation constellation is adapted to distribute the downlink transmit power between the two subchannels of the AQPSK modulated carrier, as depicted in FIG. 1. By placing modulation symbols at different positions, the relative power allocated to each of the subchannels can be controlled, as indicated by the length of the vector along each subchannel axes. Extra power can be distributed to one of the subchannels, at the expense of the paired subchannel. This allows the base station to pair VAMOS-capable mobile stations to achieve the greatest range. For example, the base station may allocate greater relative power to a mobile station towards the edge of a cell, pairing it on a VAMOS channel with a mobile station closer to the base station, which requires lower transmit power.

The power distribution between VAMOS subchannels is known as the Subchannel Power Imbalance Ratio (SCPIR) and is defined, for the first subchannel, as

$$S C P I R = 10 {log}_{10} ( \frac{Subchannel 1 power}{Subchannel 2 power} ) [ dB ]$$

Operation of the VAMOS Subchannel Power Control feature is symmetric in the sense that if one mobile is allocated on SCPIR +4 dB, the paired mobile is allocated on SCPIR −4 dB. At SCPIR 0 dB, both VAMOS mobiles are allocated equal downlink power. As used herein, the term “SCPIR level” refers to the numeric value of the SCPIR for the relevant subchannel—that is, the subchannel used to attempt communications with a particular mobile station when using VAMOS (i.e., AQPSK modulation).

3GPP Release 9 introduces two levels of VAMOS-capable mobile stations, VAMOS I and VAMOS II. These mobile stations are aware of a new set of training sequences, optimized for VAMOS, and will guarantee the best possible speech quality and network performance. Additionally, most legacy mobile stations have sufficient interference cancellation capability to be able to receive a signal on a VAMOS subchannel (suppressing the paired subchannel as interference), at least at sufficiently high SCPIR levels. In particular, mobile stations having Single Antenna Interference Cancellation (SAIC), also known in the art as Downlink Advanced Receiver Performance (DARP) phase I, capability may receive and process VAMOS transmissions at fairly low SCPIR levels.

Furthermore, even some non-SAIC mobile stations may be able to receive and process VAMOS transmissions at high SCPIR levels. In one sense, all mobile stations can be considered VAMOS-capable. Referring back to FIG. 1, in the trivial case of 100% of the power of an AQPSK modulated signal being allocated to one subcarrier and 0% to the other subcarrier, the result would be tantamount to a conventional GMSK modulated signal on the 100% subcarrier. In practical terms, the parameter of interest is how low of a SCPIR level a given mobile station can receive and process. If it is sufficiently low, the mobile station becomes a candidate for pairing with another mobile station for operation in VAMOS mode. As used herein, a mobile station is considered “VAMOS capable” if it can receive and process AQPSK modulated signals at or above a predetermined SCPIR level, wherein the predetermined SCPIR level is sufficiently low that meaningful power remains to be allocated to another mobile station in a VAMOS pair. This specific predetermined SCPIR level may, of course, vary in different implementations, but in general it is readily determinable by those of skill in the art, without undue experimentation, given the teachings of the present disclosure.

The capabilities of a mobile station may be discovered by the network in numerous ways. For example, a mobile station may explicitly enumerate its capabilities during call setup. Alternatively, the network may be provisioned with a list of capabilities common to all mobile stations of a particular type (e.g., make and model number, software version number, and the like), and the mobile station may identify its type during call setup. Furthermore, the network may explicitly query a mobile station during call setup as to its capabilities.

Many mobile stations exhibit at least SAIC/DARP phase I performance. However, many of these mobile stations are not “certified” as having this capability, due perhaps to the expense of the testing regimen necessary to qualify them as such, among other reasons. Accordingly, they do not signal this capability to the network; the capability is not listed as an attribute of the mobile station type; and the mobile stations will not respond to a query as having the capability—even though they do in fact have the technical ability to cancel interference sufficiently to accurately receive an AQPSK modulated signal on a VAMOS subchannel at a lower SCPIR level than a mobile not supporting SAIC could normally handle. Since the network can double its capacity by employing VAMOS, there exists a need in the art for a GSM network to be able to “blindly” identify the SCPIR handling capability of mobile stations—that is, ascertain the lowest SCPIR at which the mobile can operate by means other than those described above. Further, such blind detection should ideally not occur using any portion of a traffic channel, so as to not degrade user-perceived call quality.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure is not intended to identify key/critical elements of embodiments of the invention or delineate the scope of the invention. The sole purpose of this summary is to present some concepts disclosed herein in a simplified form as a prelude to the more detailed description that is presented later.

According to one or more embodiments described and claimed herein, a network is able to determine whether a mobile station is capable of receiving and interpreting VAMOS transmissions of a predetermined SCPIR level, and in some embodiments the lowest SCPIR level the mobile station can reliably receive. The network transmits an AQPSK modulated message at a predetermined SCPIR level on a control channel or non-traffic portion of a traffic channel, and monitors the mobile station for an anticipated action taken in response. In some embodiments, the AQPSK modulated message is repeated to increase the probability of its reception. In some embodiments, AQPSK modulated messages are transmitted at varying SCPIR levels, to determine the minimum SCPIR level or range of SCPIR levels, in which the mobile terminal is operative in VAMOS mode. Due to this blind detection, the network is able to discover mobile stations having operative VAMOS capability that do not signal or otherwise publish this information (and verify the VAMOS capability of those that do). Network operations can then be made more efficient by use of VAMOS pairing of mobile stations.

One embodiment relates to a method of blindly detecting the capability of a mobile station to receive VAMOS transmissions. At least one AQPSK modulated message having a predetermined SCPIR level is transmitted to the mobile station on a control channel or non-traffic portion of a traffic channel. The mobile station is monitored for an anticipated action responsive to the AQPSK modulated message. It is determined that the mobile station is capable of VAMOS operation at the transmitted SCPIR level or higher SCPIR levels if the anticipated action is observed, an indication of the determined SCPIR level of VAMOS capability is associated with the mobile station.

Another embodiment relates to an apparatus operative in a wireless communication network. The apparatus is operative to blindly detect the capability a mobile station to receive VAMOS transmissions. The apparatus includes a transceiver operative to selectively transmit messages modulated using AQPSK modulation, and further operative to receive signals from a plurality of mobile stations. The apparatus also includes memory operative to store identifying information associated with a plurality of mobile stations. The apparatus additionally includes one or more controllers. The controllers are operative to cause the transceiver to transmit at least one AQPSK modulated message having a predetermined SCPIR level to the mobile station on a control channel or non-traffic portion of a traffic channel; monitor signals received by the transceiver from the mobile station for an anticipated action responsive to the AQPSK modulated message; determine that the mobile station is capable of VAMOS operation at the transmitted SCPIR level or higher SCPIR levels if the anticipated action is observed; and store in the memory an indication of VAMOS capability and an SCPIR level.

### BRIEF DESCRIPTION OF THE DRAWINGS

FIG. 1 depicts two symbol constellation diagrams for AQPSK modulation, demonstrating the relative power allocated to different subchannels.

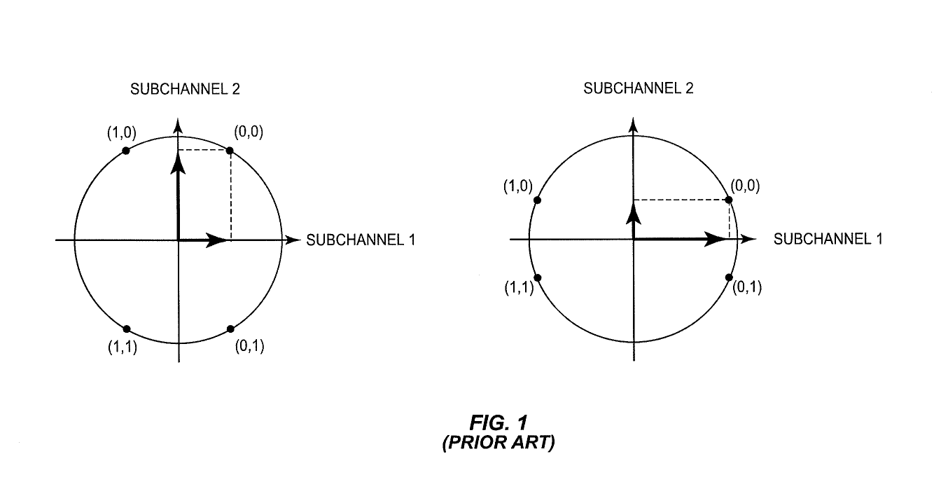

FIG. 2 is a functional block diagram of a GSM network employing VAMOS.

FIG. 3 is a graph showing the reception differences for VAMOS transmissions between SAIC and non-SAIC mobile stations for a SCPIR level of −2 dB.

FIG. 4 depicts two signaling diagrams.

FIG. 5 depicts SACCH and SID information during four multi-frames.

FIG. 6 is a flow diagram of a method of blindly detecting the capability of a mobile station to receive VAMOS transmissions.

FIG. 7 is a functional block diagram of a base station system.

### DETAILED DESCRIPTION

The following description sets forth specific details, such as particular embodiments, procedures, techniques, etc., for purposes of explanation and not limitation. In some instances, detailed descriptions of well known methods, interfaces, circuits, and devices are omitted so as not obscure the description with unnecessary detail. Moreover, individual blocks are shown in some of the drawings. Those of skill in the electronics and processing arts will readily appreciate that the functions of those blocks may be implemented using individual hardware circuits; using software programs and data, in conjunction with one or more suitably programmed digital microprocessors, digital signal processors, or general purpose computers; using application specific integrated circuitry, using programmable logic or gate arrays and associated firmware, or any combination of the above.

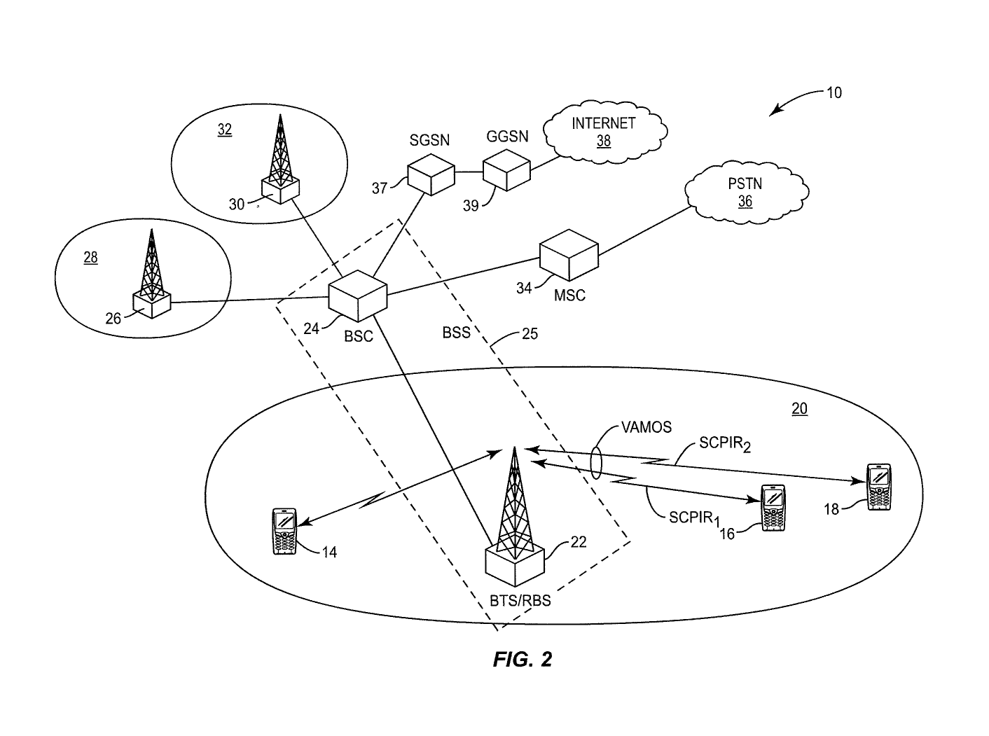

FIG. 2 depicts relevant portions of a GSM wireless communication network 10 operative to blindly detect VAMOS-capable mobile stations. The network 10 provides mobile communication services to mobile stations 14, 16, 18, such as radiotelephones, in a geographic region, or cell 20. Radio communication services are provided in the cell 20 by a Base Transceiver Station (BTS) 22, also known in the art as a Radio Base Station (RBS). The BTS/RBS 22 includes equipment necessary to establish wireless communications, such as transceiver circuits performing e.g., signal processing, modulation, amplification, and the like. The BTS/RBS 22 may also perform data processing such as en/de-cryption, interleaving, error correction coding, and the like. The BTS/RBS 22 is typically located at a cell tower, and may be considered to include one or more antennas. The BTS/RBS 22 is operatively coupled to, and controlled by, a Base Station Controller (BSC) 24. In addition to the BTS/RBS 22, the BSC 22 may control other BTSs, such as BTS 26 providing communication services in cell 28, and BTS 30 in cell 32. The BSC 24 controls the allocation of air interface resources to mobile stations 14, 16, 18 in various cells 20, 28, 32. As well known in the art, the precise division of tasks between the BTS/RBS 22 and BSC 24 may vary by implementation, equipment and software version, configuration by the network operator, and the like. Accordingly, the BTS/RBS 22 and BSC 24 together are collectively referred to as a Base Station System (BSS) 25.

The BSC 24 is communicatively coupled to a Mobile Switching Center (MSC) 34 operative to manage communication sessions for mobile equipment, e.g., providing mobility management functions, authentication, billing, and the like. The MSC 34 is connected to, and provides interoperability with, other communication networks, such as the Public Switched Telephone Network (PSTN) 36. The BSC 24 additionally interfaces to packet data networks, such as the Internet 38, through a Serving GPRS Support Node (SGSN) 37 and Gateway GPRS Support Node (GGSN) 39. Numerous nodes of the wireless communication network 10, such as Home and Visitor Location Registers (HLR/VLR), Authentication, Authorization, and Accounting (AAA) nodes, and the like are omitted for clarity.

The BSS 25 provides conventional GSM wireless communication services to a non-SAIC mobile station 14. The BSS 25 additionally provides VAMOS service to SAIC mobile stations 16, 18 on VAMOS paired subchannels. In this example, the mobile station 18 receives transmissions at a higher SCPIR level than the mobile station 16, as it is further from the BTS/RBS 22 (that is, SCPIR₂>SCPIR₁). Before the network 10 can provide VAMOS service to the mobile stations 16, 18, it must discover their VAMOS capability. Because a large number of GSM mobile stations 14, 16, 18 do not signal their VAMOS capability, the network 10 must blindly determine it. According to embodiments of the present invention, the network 10 blindly determines the VAMOS capability, at least at a predetermined SCPIR level, of mobile stations 14, 16, 18 in the cell 20, using a control channel or non-traffic portion of a traffic channel. In some embodiments, the network 10 additionally determines a minimum SCPIR level at which a mobile station 14, 16, 18 responds to a VAMOS transmission. Various embodiments are presented, in which the network 10 determines VAMOS capability by utilizing different control and/or traffic channels.

### Paging Channel

The paging channel (PCH) is a channel used by the network 10 to broadcast a paging message as part of, e.g., a mobile terminating call setup. Once the targeted mobile station 14, 16, 18 decodes the PCH and reads a Temporary Mobile Subscriber Identifier (TMSI) or International Mobile Subscriber Identifier (IMSI) that matches its own TMSI or IMSI, it responds on a random access (RACCH) to the network 10 to acknowledge the start of the call setup. The PCH is GMSK modulated so that all mobile stations 14, 16, 18 in a cell 20 are capable of reading the paging message. If a mobile station 14, 16, 18 fails decode a page on PCH, due to low signal to noise and interference ratio (SINR), the network 10 can optionally repeat the broadcast until the mobile station 14, 16, 18 replies.

According to one embodiment of the present invention, paging messages are transmitted on an AQPSK modulated subchannel for blind detection of VAMOS capability at a predetermined SCPIR level. The paging messages are allocated a SCPIR level that guarantees, first, that non-VAMOS capable mobile stations 14—that is, mobile stations that can only receive and process VAMOS signals at very high SCPIR levels, such as non-SAIC mobile stations 14 and some SAIC mobile stations, can not decode the PCH and read the paging message. Second, the SCPIR level is chosen such that VAMOS capable mobile stations 16, 18, such as most SAIC mobile stations, can read the paging message and respond on a RACCH.

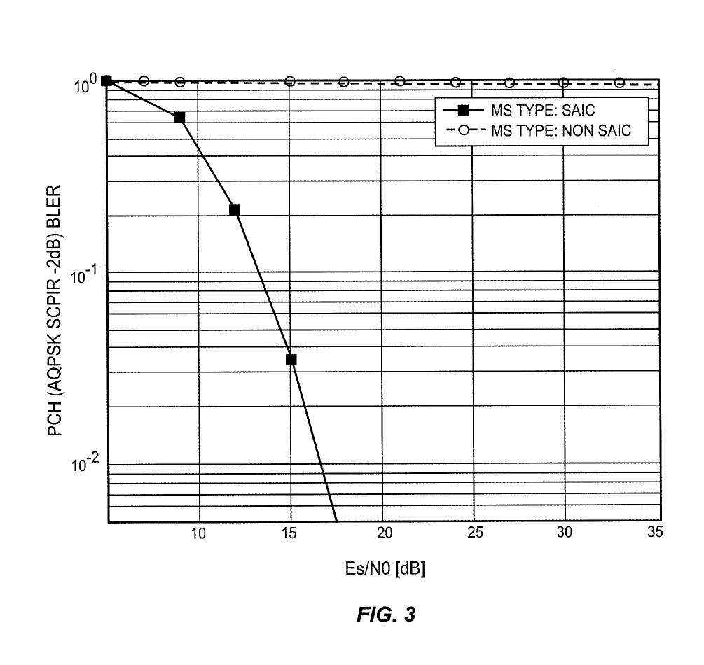

In this manner, the network 10 may blindly detect VAMOS capable mobile stations 16, 18 and allocate those in a VAMOS pair on a traffic channel (TCH). The graph of FIG. 3 depicts simulated PCH Block Error Rates (BLER) for two mobile types—SAIC and non-SAIC—when the PCH is sent over an AQPSK subchannel with SCPIR level of −2 dB. FIG. 3 shows that the second objective—correct decode by SAIC mobile stations 16, 18—is fulfilled for a SCPIR of −2 dB over the entire range of simulated signal to noise ratio (SNR) values. FIG. 3 further shows that the first objective—that the message not be decoded by non-SAIC mobile stations 14—depends on the SNR experienced by the mobile station 14. In this case, for SNR above 17 dB, the PCH will be incorrectly decoded with a probability P(PASS|SAIC MS, SNR 17 dB) of 99%, and the blind detection can be considered robust.

In one embodiment, where the mobile station 14, 16, 18 experiences low SNR, the detection can be made more robust by sending N consecutive AQPSK modulated paging messages. The probability that the paging message will be correctly read is then 1−P(FAIL|SAIC MS, SNR)^{N}. If the N first AQPSK modulated PCH radio blocks fail, the network 10 may send the N+1^{st} paging message on a conventional GMSK modulated PCH. In one embodiment, to increase the probability of a response from the mobile, the SCPIR level on the relevant subchannel is changed for each repeated paging message. In this embodiment, the timing of the response by the mobile station 16, 18 (together with the direction and magnitude of the SCPIR level change) indicates to the network 10 the minimum SCPIR level to which the mobile station 16, 18 will respond. The network 10 may then allocate this mobile terminal to a VAMOS pair at the minimum SCPIR level, or any higher SCPIR level. In one embodiment, a margin is added to the determined minimum SCPIR level, for reliability and to guard against, e.g., varying channel quality, the mobile moving further from the BTS/RBS 22 during a call, and the like.

### Access Grant Channel

The Access Grant channel is used in both mobile originating and terminating call setup procedures to assign a channel to a mobile station 14, 16, 18. An immediate assignment message is sent on the Access Grant channel, directing the mobile station 14, 16, 18 to a signaling channel. In two embodiments of the present invention, the network 10 can use the Access Grant Channel to identify not only which mobile stations 16, 18 are VAMOS capable at a predetermined SCPIR level, but additionally determine the minimum SCPIR level at which the mobile stations 16, 18 can interpret AQPSK modulated messages.

One embodiment operates similarly to the PCH method described above, but instead of repeating a paging message, the network 10 sends an immediate assignment on the Access Grant channel using AQPSK modulation. The transmission is repeated at different (e.g., increasing) SCPIR levels until the mobile station 16, 18 understands the message, tunes to the allocated signaling channel, and responds. The timing of the mobile station 16, 18 response (together with the details of changing the SCPIR level) will then indicate to the network 10 the range of SCPIR levels in which the mobile station 16, 18 is operative. The SCPIR level may cycle from a low value and successively increase, to determine a minimum SCPIR level. Alternatively, the SCPIR level may initially be large, to immediately ascertain whether the mobile station 16, 18 is VAMOS capable, with subsequent messages transmitted at successively lower SCPIR levels, directing the mobile station 16, 18 to tune to different signaling channels, to ascertain the lower SCPIR limit. Since a mobile receives only one Access Grant message per call, this process may proceed over a plurality of calls, with the SCPIR data associated with the mobile station being stored by the network 10 between calls.

In another embodiment, the Access Grant channel is used to allocate a plurality of signaling channels to a mobile station 16, 18. One immediate assignment is sent, using AQPSK modulation, for each allocated signaling channel. The SCPIR level is altered (e.g., increased) for each assignment sent. By monitoring on which signaling channel the mobiles responds, the network 10 may ascertain the SCPIR level to which the mobile station 16, 18 responds. Blind VAMOS capability detection is faster in this embodiment than the previous method, but it consumes more signaling resources in the network 10. Also, this embodiment is only practicable when multiple signaling channels are available.

### Dedicated Control Channel and Signaling on Traffic Channels

A dedicated control channel is a dedicated signaling link between the network 10 and a mobile station 14, 16, 18. A similar signaling link can be achieved on a traffic channel using the Fast Associated Control CHannel (FACCH). Both dedicated control channels and traffic channels have Slow Associated Control CHannels (SACCH) carrying signaling information needed to maintain the channel. According to various embodiments of the present invention, these control channels can be used to blindly detect the VAMOS capability (at a predetermined SCPIR level) of a mobile station 14, 16, 18.

In one embodiment, network layer 2 (L2) signaling on a stand-alone dedicated control channel (SDCCH), or FACCH signaling associated with a traffic channel, is used for VAMOS blind detection. The signaling between the BTS/RBS 22 and a mobile station 14, 16, 18 on these channels is protected by the L2 parameters T200 and N200. In an acknowledge mode, used in the conventional SDCCH and FACCH signaling procedures, a L2 message is repeated if it is not acknowledged within T200 milliseconds. This is done N200 times. Typically on the SDCCH channel the T200=200 ms and N200=23, and on a FACCH channel T200=140 ms and N200=34.

The network 10 transmits the L2 message from the BTS/RBS 22 to the mobile station 14, 16, 18 on a VAMOS subchannel with a specific SCPIR level, for example −2 dB, and monitors the mobile station 14, 16, 18 for a L2 acknowledgment of the message. If an acknowledgment is received the network 10 concludes that the mobile station 16, 18 is VAMOS capable at the selected, and all higher, SCPIR levels.

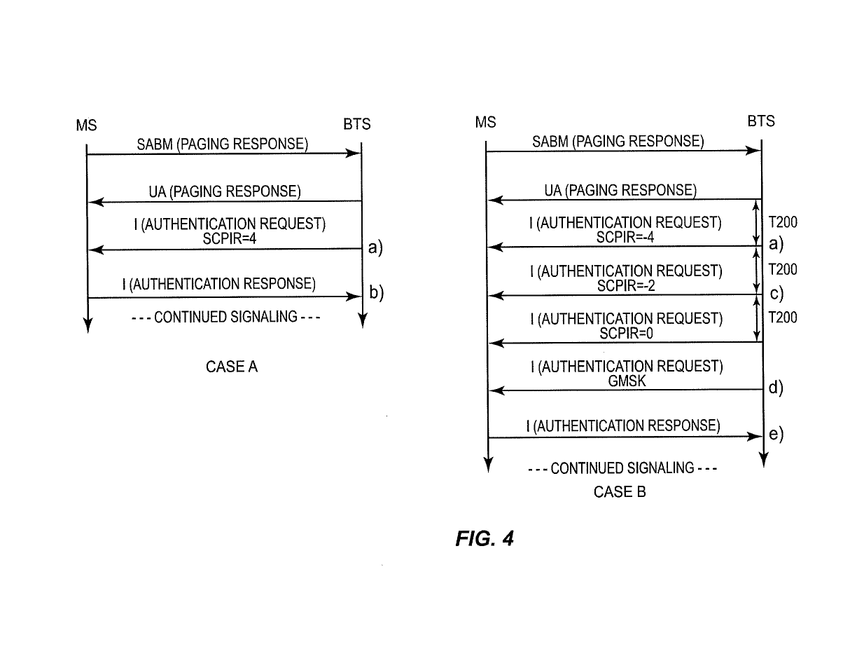

One non-limiting example illustrating this embodiment is described with reference to FIG. 4. A normal information (I) frame, such as an I-frame carrying a layer 3 message such as an AUTHENTICATION REQUEST, CHIPHERING MODE COMMAND, SETUP, or CALL PROCEEDING is used to detect if a mobile station 14, 16, 18 is VAMOS capable.

In CASE A of FIG. 4, at a) an AUTHENTICATION REQUEST is transmitted in a L2 I-frame using AQPSK modulation with a SCPIR level of −4 dB. The mobile station 16, 18 receives and processes this message, and responds at b) with a L2 acknowledgement. The conclusion is thus that this mobile station 16, 18 can understand AQPSK modulation and suppress the other paired channel, and consequently can be allocated onto a VAMOS subchannel with a SCPIR level ≧−4 dB.

In CASE B of FIG. 4, at a) the AUTHENTICATION REQUEST is transmitted in a L2 I-frame using AQPSK modulation with a SCPIR level of −4 dB. However, in this case a targeted mobile station 14 is not capable of decoding the message and does not respond. After T200 ms, at c), the BTS/RBS 22 tries again with the same AUTHENTICATION REQUEST but with a SCPIR level of −2 dB. Also here, T200 times out before a response is received. When the BTS/RBS 22 has transmitted the message at several different (in the depicted example, increasing) SCPIR levels, and has not received a response, the AUTHENTICATION REQUEST is finally transmitted using conventional GMSK modulation at d) and the successful response is received in an L2 acknowledgement at e). The conclusion in CASE B is that this mobile station 14 cannot be allocated onto a VAMOS subchannel. This conclusion may be reached more quickly beginning with a high SCPIR level to ascertain VAMOS capability, then, if successful, decreasing the SCPIR level to determine the range in which a mobile station 16, 18 may operate. In this latter case, the subsequent testing is done on later messages in L2 acknowledge mode, or in later calls.

To make these methods more robust and guard against failed decoding due to reasons such as the mobile station 14, 16, 18 experiencing deep fading dips, the AQPSK modulated messages may be retransmitted multiple times at each SCPIR level, prior to incrementing (or decrementing) the SCPIR level. Also, since only mobile stations 14, 16, 18 with good signal strength are candidates for VAMOS, this polling should only be done for mobile stations 14, 16, 18 that report received signal strength above an applicable threshold value.

In another embodiment, which avoids a direct impact to the signaling channels, as well as avoiding any increase in signaling load, AQPSK modulation can also be used for VAMOS capability blind detection on the SACCH, even if the associated speech traffic channels are in non-VAMOS mode. In this case, non-VAMOS capable mobile stations 14, such as non-SAIC and some SAIC implementations, cannot decode an AQPSK modulated SACCH at a sufficiently low SCPIR level, and will indicate this with a severely degraded received quality metric (RXQUAL) in the mobile station 14 measurement report (i.e., a drop in the reported quality metric that exceeds an applicable threshold). On the other hand, VAMOS capable mobile stations 16, 18, such as most SAIC implementations, can read the SACCH and will indicate this with an unaffected or only slightly affected RXQUAL measurement report (i.e., any drop in the reported quality metric will not exceed the threshold).

On traffic channels and associated control channels, two different types of quality reports, RXQUAL_FULL and RXQUAL_SUB, are used by mobile stations 14, 16, 18. In either case the quality metric reports the received quality of messages received on both a traffic channel and its associated control channel(s). The quality metric RXQUAL_SUB is used during a speech call if there is a silent period. The RXQUAL_SUB quality report is only based on four SACCH bursts and the silence descriptor bursts. The silence descriptors comprise information transmitted during a silent period of speech, for the construction of “comfort noise” at the receiver.

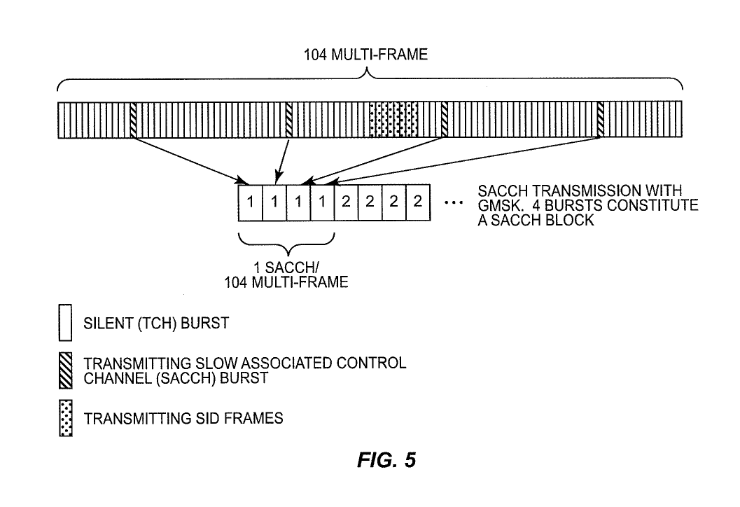

FIG. 5 depicts an example of a silent period for TCH/F using speech codec Enhanced Full Rate (EFR), where 8 SID frames are transmitted on fixed positions (frames 52-59) in the 104-multiframe, and one SACCH burst comprises four frames. If AQPSK modulation is used with, e.g., a SCPIR level of −2 dB instead of GMSK for either the SACCH or SID frames, or both, a significant degradation of RXQUAL_SUB reports can be expected for non-VAMOS capable mobile stations 14. These mobile stations 14 will exhibit, for the SACCH and/or SID frames, BLERs similar to that depicted in FIG. 3 for a non-SAIC mobile station 14 on the PCH. In this case, the mobile stations 14 will report RXQUAL 7, regardless of the previously reported RXQUAL value. On the other hand, for VAMOS capable mobile stations 16, 18, the RXQUAL degradation is expected to be more controlled. In one embodiment of the present invention, this expected difference in reported RXQUAL_SUB values is used as basis of blind detection of the VAMOS capability of mobile stations 16, 18. Of course, the RXQUAL_SUB values will vary over time as channel conditions change; it is only a dramatic drop in the RXQUAL_SUB value (e.g., in excess of an applicable threshold), occurring in direct response to the transmission of AQPSK modulated SACCH and/or SID data, that would indicate non-VAMOS capability (at the tested SCPIR value). Those of skill in the art will recognize that the mobile station reporting an unaffected, improved, or only slightly reduced quality metric in response to receiving AQPSK modulated information constitutes an anticipated action by the mobile terminal, for which the network 10 monitors to ascertain VAMOS capability.

In another embodiment, the RXQUAL_FULL metric associated with a period of active speech (i.e., not silence) is used, where AQPSK modulation at a predetermined SCPIR level is still only applied to SACCH bursts. However, in this case, the report will constitute both 96 TCH/F bursts modulated using GMSK and only 4 SACCH bursts modulated using AQPSK. The detection of a modification of RXQUAL in this case is more delicate, as the overall degradation for a non-VAMOS capable mobile station 14 is much less than in the case of a silent period where only SID and no speech is carried on traffic channel (where the SACCH burst and SID frames are the only data transmitted). Those of skill in the art will recognize that these embodiments can easily be extended to apply also for half rate (HR) channels and to SDCCH channels, where AQPSK modulation is only applied to the SACCH bursts, to avoid impact on the SDCCH signaling messages.

One drawback to these embodiments is that the SACCH and SID frames will be lost when transmitted to a non-VAMOS capable mobile station 14. This means the SACCH update rate of the mobile station 14 will decrease, and it will not be able to read the silent descriptor for the generation of comfort noise. However, in particular applications this drawback may be mitigated in that: the SACCH update rate may be decreased to one-half by the use of the 3GPP-specified Repeated SACCH feature; the use of AQPSK modulation is expected to have less impact to the ongoing call when applied during a silent period than in an active period; the AQPSK modulated transmission need not be applied in all silent periods of the call, but rather only until it is determined whether the mobile station 14, 16, 18 is VAMOS capable or not; and a threshold may be used to only apply this method, for example, in case of the call being down regulated by X dB and/or the reported quality is sufficiently high.

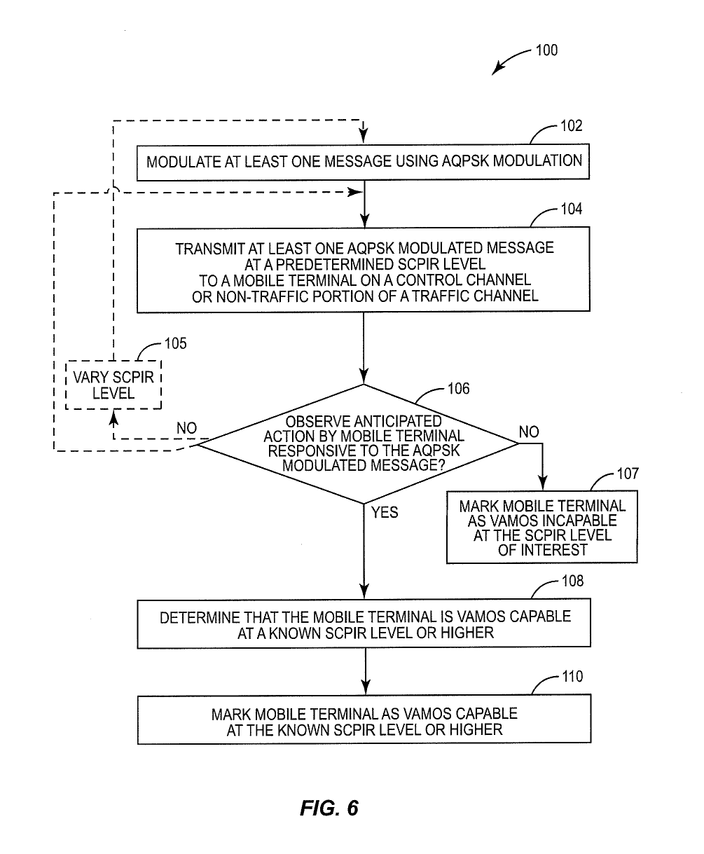

FIG. 6 depicts an overall method 100 of blind detection of VAMOS capability. A GSM wireless communication network 10 modulates at least one message using AQPSK modulation at a predetermined SCPIR level (block 102). A BTS/RBS 22 in the network 10 transmits at least one AQPSK modulated message to a mobile station 14, 16, 18 on a control channel or non-traffic portion of a traffic channel (block 104), at the selected SCPIR level. The network 10 monitors the mobile station 14, 16, 18 for an anticipated action responsive to the AQPSK modulated message (block 106). In some embodiments, if the anticipated action by the mobile station 14, 16, 18 is not immediately observed, the AQPSK modulated message is repeated. In some embodiments, the SCPIR level may be varied (block 105) after one or more AQPSK modulated transmissions, and another AQPSK modulated message generated and transmitted at a different SCPIR level. These alternative embodiments are indicated in FIG. 6 by dashed lines.

If (in some embodiments, after sufficient retransmissions and/or having varied the SCPIR level sufficiently) the anticipated action by the mobile station 14, 16, 18 is not observed (block 106), the mobile station 14 is determined to be not VAMOS capable at the SCPIR levels of interest, and an indication of this fact may be associated with the mobile station (block 107) for future reference. However, if the anticipated action by the mobile station 16, 18 is observed (block 106), then the network 10 determines that the mobile station 16, 18 is VAMOS capable at the selected SCPIR level or higher SCPIR levels (block 108). An indication of this fact is stored (block 110) so that the mobile station 16, 18 may be paired with another mobile station 16, 18 for VAMOS mode operation. In one embodiment, a margin is added to the ascertained SCPIR level at which the mobile station 16, 18 responds, for reliability and to guard against, e.g., varying channel quality, the mobile station 16, 18 moving further from the BTS/RBS 22 during a call, and the like. In some embodiments, the VAMOS capability indication (and SCPIR level) is stored only for the duration of the call. In other embodiments, the indication may be stored by the network 10 over the course of two or more calls to/from the mobile station 16, 18.

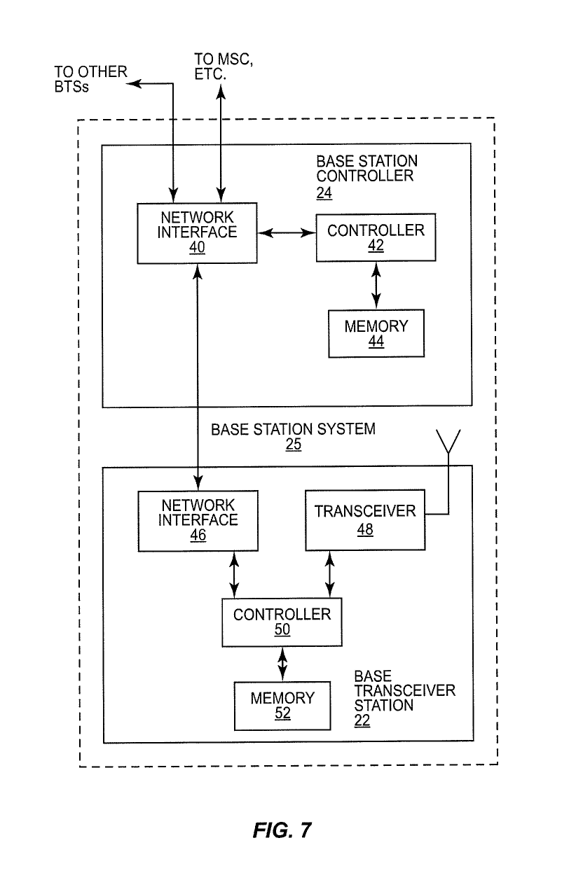

FIG. 7 depicts a hardware block diagram of the base station system (BSS) 25, comprising a BTS/RBS 22 and BSC 24. The BSC 24 includes a network interface 40 operative to forward communications between mobile stations 14, 16, 18 and networks 36, 38 (see FIG. 2) via the MSC 34. The network interface 40 is further operative to interface the BSC 24 with the BTS/RBS 22, as well as other BTS/RBS 26, 30 that the BSC 24 controls.

The BSC 24 additionally includes a controller 42, operatively coupled to memory 44. The controller 42 may comprise any sequential state machine operative to execute machine instructions stored as machine-readable computer programs in the memory 44, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the these. The memory 44 may comprise any non-transient, machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like.

Similarly, the BTS/RBS 22 includes a network interface 46 operative to interface the BTS/RBS 22 with the BSC 24, as well as a controller 50 operatively coupled to memory 52, as described above. The BTS/RBS 22 additionally includes a transceiver 48 operative to provide wireless communication service to mobile stations 14, 16, 18 in a cell 20 over an air interface. In particular, under the control of the controller 50, the transceiver 46 is operative to modulate messages according to at least GMSK and AQPSK modulation schemes, and transmit the messages at various SCPIR levels.

As discussed above, the precise division of functionality between a BTS/RBS 22 and BSC 24 may vary in different implementations, and may in fact change over time for any given BSS 25. Similarly, many of the tasks in various embodiments of the present invention may be performed by either the BTS/RBS 22 or the BSC 24. As mentioned above, the BTS/RBS 22 transmits the AQPSK modulated messages via the transceiver 48. Similarly, the tasks of maintaining lists of VAMOS capable mobile stations 16, 18 and non-VAMOS capable mobile stations 14, the pairing of mobile stations 16, 18 into VAMOS pairs, and the like are, in most embodiments, performed in the BSC 24.

However, in various embodiments, other tasks associated with embodiments of the present invention may be performed in either the BTS/RBS 22 or the BSC 24—the decision being a design choice well within the capabilities of those of skill in the art, given the teachings of the present disclosure. As non-limiting examples, the AQPSK modulation, and the concomitant determination of SCPIR levels; decisions such as whether to transmit AQPSK modulated messages such as page on a PCH, access grant on an Access Grant Channel, messages such as, e.g., power control order, system info, or timing advance on a SACCH or silence descriptors on a traffic channel; the monitoring of various channels for an anticipated response by a mobile station 14, 16, 18; tracking the VAMOS capable mobile stations 16, 18 and non-VAMOS capable mobile stations 16, 18; determining the SCPIR level to use for a given transmission; and the like may, in various embodiments, be performed by the BTS/RBS 22 or the BSC 24. Indeed, in some embodiments, the division of tasks may change, such as pursuant to a software update or system reconfiguration. As used herein, the term “apparatus” encompasses both the BTS/RBS 22 and BSC 24 individually, and also the two nodes operating together.

Embodiments of the present invention enable VAMOS operation on mobile stations that do not explicitly signal their support for VAMOS to the network 10 (or otherwise publish such capability). This will increase the VAMOS efficiency in the network 10 and thereby increase the traffic channel capacity. The mobile stations 14, 16, 18 are evaluated blindly at the beginning of, or during, a call. In some embodiments, the VAMOS capability information is kept only as long as the call is ongoing, and is deleted at the termination of each call. In other embodiments—particularly those involving a ramping of the SCPIR level to ascertain the precise capabilities of mobile terminals—is stored in the network 10 between calls. Similarly, in some embodiments, VAMOS capability information may be included in information received by the network 10 during handover of an ongoing call; in other embodiments, such information is not provided and must be ascertained once the mobile station 14, 16, 18 is operative in the network 10. A significant feature of embodiments of the present invention is that no external source of SAIC or handset type information is strictly necessary, since a blind detection can be made once the call is in the network 10.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of blindly detecting the capability of a mobile station to receive Voice services over Adaptive Multi-user channels on One Slot, VAMOS, transmissions, comprising:
transmitting at least one Adaptive Quadrature Phase Shift Keying, AQPSK, modulated message having a predetermined Sub-Channel Power Imbalance Ratio, SCPIR, level to the mobile station on a control channel or non-traffic portion of a traffic channel;
monitoring the mobile station for an anticipated action responsive to the AQPSK modulated message;
determining that the mobile station is capable of VAMOS operation at the transmitted SCPIR level or higher SCPIR levels if the anticipated action is observed; and
associating with the mobile station an indication of the determined SCPIR level of VAMOS capability.

2. The method of claim 1 wherein the AQPSK modulated message is only transmitted to a mobile station if a received signal strength reported by the mobile station exceeds a predetermined threshold.

3. The method of claim 1 wherein transmitting at least one AQPSK modulated message having a predetermined SCPIR level to the mobile station on a control channel or non-traffic portion of a traffic channel and monitoring the mobile station for an anticipated action responsive to the AQPSK modulated message comprise:
repeating the transmitting and monitoring steps until the anticipated mobile station action is observed or until a predetermined number of transmissions are performed.

4. The method of claim 1 wherein transmitting at least one AQPSK modulated message having a predetermined SCPIR level to the mobile station on a control channel or non-traffic portion of a traffic channel and monitoring the mobile station for an anticipated action responsive to the AQPSK modulated message comprise:
transmitting to the mobile station an AQPSK modulated message at a first SCPIR level;
monitoring the mobile station;
if an anticipated action by the mobile station responsive to the AQPSK modulated message at the first SCPIR level is not observed, retransmitting the AQPSK modulated message to the mobile station at a different SCPIR level and monitoring the mobile station; and
further retransmitting the AQPSK modulated message at different SCIPR levels and monitoring the mobile station until the anticipated mobile station action is observed or a predetermined SCPIR level is reached.

5. The method of claim 1
wherein transmitting at least one AQPSK modulated message having a predetermined SCPIR level to the mobile station on a control channel or non-traffic portion of a traffic channel comprises transmitting at least one AQPSK modulated message having a predetermined SCPIR level to the mobile station on a paging channel; and
wherein monitoring the mobile station for an anticipated action responsive to the AQPSK modulated message comprises monitoring a random access channel for a signal from the mobile station responsive to the paging channel message.

6. The method of claim 1
wherein transmitting at least one AQPSK modulated message having a predetermined SCPIR level to the mobile station on a control channel or non-traffic portion of a traffic channel comprises transmitting at least one AQPSK modulated message having a predetermined SCPIR level to the mobile station on an access grant channel; and
wherein monitoring the mobile station for an anticipated action responsive to the AQPSK modulated message comprises monitoring at least one signaling channel allocated to the mobile station in the access grant channel message, for a response from the mobile station.

7. The method of claim 6
wherein transmitting at least one AQPSK modulated message having a predetermined SCPIR level to the mobile station on an access grant channel comprises successively transmitting a plurality of AQPSK modulated message to the mobile station on the access grant channel, each successive message transmitted at a different SCPIR level and directing the mobile station to respond on a different signaling channel; and
wherein monitoring at least one signaling channel allocated to the mobile station in the access grant channel message, for a response from the mobile station comprises monitoring each signaling channel included in a message transmitted on the access grant channel; and
wherein determining that the mobile station is capable of VAMOS operation at the transmitted SCPIR level or higher SCPIR levels if the anticipated action is observed comprises determining, from the signaling channel on which the mobile station is detected, an SCPIR level at which the mobile station responds to AQPSK modulated messages.

8. The method of claim 1
wherein transmitting at least one AQPSK modulated message having a predetermined SCPIR level to the mobile station on a control channel or non-traffic portion of a traffic channel comprises transmitting at least one AQPSK modulated layer 2 information frame to the mobile station; and
wherein monitoring the mobile station for an anticipated action responsive to the AQPSK modulated message comprises monitoring for a layer 2 acknowledgement that the mobile station has received the AQPSK modulated layer 2 information frame.

9. The method of claim 8 wherein transmitting at least one AQPSK modulated layer 2 information frame to the mobile station and monitoring for a layer 2 acknowledgement that the mobile station has received the AQPSK modulated layer 2 information frame comprise successively transmitting an AQPSK modulated layer 2 information frame to the mobile station at a varying SCPIR levels until a layer 2 acknowledgement is detected or a predetermined SCPIR level is reached.

10. The method of claim 9 wherein determining that the mobile station is capable of VAMOS operation at the transmitted SCPIR level or higher SCPIR levels if the anticipated action is observed comprises determining, from the timing of the layer 2 acknowledgement, an SCPIR level at which the mobile station responds to AQPSK modulated messages.

11. The method of claim 9 wherein successively transmitting an AQPSK modulated layer 2 information frame to the mobile station at a varying SCPIR level comprises transmitting a plurality of AQPSK modulated layer 2 information frames to the mobile station at each SCPIR level prior to varying the SCPIR level.

12. The method of claim 1
wherein transmitting at least one AQPSK modulated message having a predetermined SCPIR level to the mobile station on a control channel or non-traffic portion of a traffic channel comprises transmitting at least one message to the mobile station on a Slow Associated Control Channel associated with a traffic channel; and
wherein monitoring the mobile station for an anticipated action responsive to the AQPSK modulated message comprises monitoring a quality report received from the mobile station.

13. The method of claim 1
wherein transmitting at least one AQPSK modulated message having a predetermined SCPIR level to the mobile station on a control channel or non-traffic portion of a traffic channel comprises transmitting at least one AQPSK modulated silence descriptor providing silence descriptor parameters used for the generation of comfort noise; and
wherein monitoring the mobile station for an anticipated action responsive to the AQPSK modulated message comprises monitoring a quality report received from the mobile station.

14. An apparatus operative in a wireless communication network, the apparatus operative to blindly detect the capability a mobile station to receive Voice services over Adaptive Multi-user channels on One Slot, VAMOS, transmissions, comprising:
a transceiver operative to selectively transmit messages modulated using Adaptive Quadrature Phase Shift Keying, AQPSK, modulation and further operative to receive signals from a plurality of mobile stations;
memory operative to store identifying information associated with a plurality of mobile stations; and
one or more controllers operative to
cause the transceiver to transmit at least one AQPSK modulated message having a predetermined Sub-Channel Power Imbalance Ratio, SCPIR, level to the mobile station on a control channel or non-traffic portion of a traffic channel;
monitor signals received by the transceiver from the mobile station for an anticipated action responsive to the AQPSK modulated message;
determine that the mobile station is capable of VAMOS operation at the transmitted SCPIR level or higher SCPIR levels if the anticipated action is observed; and
store in the memory an indication of VAMOS capability and an SCPIR level.

15. The apparatus of claim 14 wherein one or more controllers are operative to transmit the AQPSK modulated messages having a predetermined SCPIR level to the mobile station and monitor signals received by the transceiver from the mobile station for an anticipated action by repeating the transmitting and monitoring steps until the anticipated mobile station action is observed or until a predetermined number of transmissions are performed.

16. The apparatus of claim 14 wherein one or more controllers are operative to cause the transceiver to transmit the AQPSK modulated Message having a predetermined SCPIR level to the mobile station and monitor signals received by the transceiver from the mobile station for an anticipated action by
causing the transceiver to transmit to the mobile station an AQPSK modulated message at a first SCPIR level;
monitoring signals received by the transceiver from the mobile station;
if an anticipated action by the mobile station is not observed, causing the transceiver to retransmit the AQPSK modulated message to the mobile station at a different SCPIR level and to monitor the mobile station; and
further causing the transceiver to retransmit the AQPSK modulated message at different SCIPR levels and to monitor the mobile station until the anticipated mobile station action is observed or a predetermined SCPIR level is reached.

17. The apparatus of claim 14 wherein one or more controllers are operative to
cause the transceiver to transmit at least one AQPSK modulated message having a predetermined SCPIR level to a mobile station by causing the transceiver to transmit at least one AQPSK modulated message having a predetermined SCPIR level to the mobile station on a paging channel; and
monitor signals received by the transceiver from the mobile station for an anticipated action by monitoring a random access channel for a signal from the mobile station responsive to the paging channel message.

18. The apparatus of claim 14 wherein one or more controllers are operative to
cause the transceiver to transmit at least one AQPSK modulated message having a predetermined SCPIR level to a mobile station by causing the transceiver to transmit at least one AQPSK modulated message having a predetermined SCPIR level to the mobile station on an access grant channel; and
monitor signals received by the transceiver from the mobile station for an anticipated action by monitoring at least one signaling channel allocated to the mobile station in the access grant channel message, for a response from the mobile station.

19. The apparatus of claim 18 wherein one or more controllers are operative to
cause the transceiver to transmit at least one AQPSK modulated message having a predetermined SCPIR level to the mobile station on an access grant channel by causing the transceiver to transmit a plurality of AQPSK modulated message to the mobile station on the access grant channel, each message transmitted at a different SCPIR level and directing the mobile station to respond on a different signaling channel; and
monitor at least one signaling channel allocated to the mobile station in the access grant channel message by monitoring each signaling channel included in a message transmitted on the access grant channel; and
determine that the mobile station is capable of VAMOS operation at the transmitted SCPIR level or higher SCPIR levels if the anticipated action is observed by determining, from the signaling channel on which the mobile station is detected, a SCPIR level at which the mobile station responds to AQPSK modulated messages.

20. The apparatus of claim 14 wherein one or more controllers are operative to
cause the transceiver to transmit at least one AQPSK modulated message having a predetermined SCPIR level to a mobile station by causing the transceiver to transmit at least one AQPSK modulated layer 2 information frame to the mobile station at the predetermined SCPIR level; and
monitor signals received from the mobile station by the transceiver for an anticipated action by monitoring for a layer 2 acknowledgement that the mobile station has received the AQPSK modulated layer 2 information frame.

21. The apparatus of claim 20 wherein one or more controllers are operative to cause the transceiver to transmit at least one AQPSK modulated layer 2 information frame to the mobile station at the predetermined SCPIR level and monitoring for a layer 2 acknowledgement that the mobile station has received the AQPSK modulated layer 2 information frame by transmitting an AQPSK modulated layer 2 information frame to the mobile station at a different SCPIR level until a layer 2 acknowledgement is detected or a predetermined SCPIR level is reached.

22. The apparatus of claim 21 wherein one or more controllers are further operative to determine, from the timing of the layer 2 acknowledgement, an SCPIR level at which the mobile station responds to AQPSK modulated messages.

23. The apparatus of claim 21 wherein one or more controllers are operative to cause the transceiver to successively transmit an AQPSK modulated layer 2 information frame to the mobile station at a different SCPIR level by transmitting a plurality of AQPSK modulated layer 2 information frames to the mobile station at each SCPIR level prior to changing the SCPIR level.

24. The apparatus of claim 14 wherein one or more controllers are operative to
cause the transceiver to transmit at least one AQPSK modulated message at the predetermined SCPIR level to the mobile station on a control channel or non-traffic portion of a traffic channel by transmitting at least one message to the mobile station on a Slow Associated Control Channel associated with a traffic channel; and
monitor signals received by the transceiver from the mobile station for an anticipated action responsive to the AQPSK modulated message by monitoring a quality report received from the mobile station.

25. The apparatus of claim 14 wherein one or more controllers are operative to
cause the transceiver to transmit at least one AQPSK modulated message having a predetermined SCPIR level to the mobile station on a control channel or non-traffic portion of a traffic channel by transmitting at least one AQPSK modulated silence descriptor providing silence descriptor parameters used for the generation of comfort noise; and
monitor signals received by the transceiver from the mobile station for an anticipated action responsive to the AQPSK modulated message by monitoring a quality report received from the mobile station.
